(19) United States
(12) Patent Application Publication
(10) Pub. No.: US 2026/0264713 A1
(43) Pub. Date: Sep. 10, 2026

(54) Autonomous Driving Warning System For A Vehicle

(71) Applicant: Rivian IP Holdings, LLC, Irvine, CA (US)

(72) Inventors: Joe Daniel HIMMELHEBER, Redondo Beach, CA (US); Nihar SASHITTAL, Irvine, CA (US); Dan James SLIPPER, Wigston (GB); Akin AINA, Irvine, CA (US); Saumya TRIPATHI, Irvine, CA (US); Srinivasa Sastry GUNTUR, Charlotte, NC (US); ByungJoo KIM, San Jose, CA (US); Frederik Francois BOTES, Ontario, CA (US)

(21) Appl. No.: 19/547,450

(22) Filed: Feb. 23, 2026

Related U.S. Application Data
(60) Provisional application No. 63/767,232, filed on Mar. 5, 2025.

(51) Int. Cl. B60W 50/16; B60W 30/182; B60W 50/08; B60W 50/14; B60W 60/00

(52) U.S. Cl. CPC B60W 50/16; B60W 30/182; B60W 50/082; B60W 60/0053; B60W 2050/143; B60W 2540/215

(57) ABSTRACT

In certain embodiments, a system comprises a haptic input device attached to a steering wheel of a vehicle, and a controller coupled to the haptic input device. The haptic input device comprises a wheel including at least one degree of freedom, at least one sensor coupled to the wheel, and a DC motor coupled to the wheel. The DC motor includes at least two input ports and an output shaft. The DC motor is configured to generate an audible tone when a control signal is provided to the input ports, and generate an output shaft rotation when different control signals are provided to the input ports. The controller is configured to receive an audible alert request from an ECU of the vehicle, and, in response to receiving the audible alert request, generate the control signal, and simultaneously transmit the control signal to the input ports of the motor.

### CROSS-REFERENCE TO RELATED APPLICATIONS

This application claims the benefit of U.S. Provisional Application Ser. No. 63/767,232 (filed on Mar. 5, 2025), the content of which is incorporated by reference herein in its entirety.

### BACKGROUND

The present disclosure relates to vehicles. More particularly, the present disclosure relates to vehicle autonomous driving.

### SUMMARY

In certain embodiments, a system comprises a haptic input device attached to a steering wheel of a vehicle, and a controller coupled to the haptic input device. The haptic input device includes a wheel having at least one degree of freedom, at least one sensor coupled to the wheel, and a direct current (DC) motor coupled to the wheel. The DC motor includes at least two input ports and an output shaft. The DC motor is configured to generate an audible tone when a control signal is provided to the input ports, the control signal comprising a single phase pulse width modulation (PWM) signal, and generate an output shaft rotation when different control signals are provided to the input ports. The controller is configured to receive an audible alert request from an electronic control unit (ECU) of the vehicle and, in response to receiving the audible alert request, generate the control signal, and transmit the control signal to the input ports of the motor.

### BRIEF DESCRIPTION OF THE DRAWINGS

FIG. 1 depicts a diagram of an example electric vehicle (EV), in accordance with embodiments of the present disclosure.

FIG. 2 presents a block diagram of example components of the electric vehicle, in accordance with embodiments of the present disclosure.

FIG. 3A presents a diagram of example components of a control system for the electric vehicle, in accordance with embodiments of the present disclosure.

FIG. 3B presents a diagram of example components of a control system zone for the electric vehicle, in accordance with embodiments of the present disclosure.

FIG. 3C presents a diagram of example components of another control system zone for the electric vehicle, in accordance with embodiments of the present disclosure.

FIG. 3D presents a diagram of example components of another control system zone for the electric vehicle, in accordance with embodiments of the present disclosure.

FIG. 4 depicts a portion of an example cabin for the electric vehicle, in accordance with embodiments of the present disclosure.

FIG. 5 depicts an example user interface wheel for a steering wheel of the electric vehicle, in accordance with embodiments of the present disclosure.

FIG. 6 depicts a block diagram of example components of the electric vehicle, in accordance with embodiments of the present disclosure.

FIG. 7 presents a process flow diagram for generating an audible alert in the electric vehicle, in accordance with embodiments of the present disclosure.

### DETAILED DESCRIPTION

A vehicle may be operated in a variety of ways and under a variety of conditions. For example, a typical road-going vehicle may be driven in an economical or sporty manner and may drive on dry, wet, or icy roads. Vehicles that have off-road or track-focused capabilities may also be operated in the same manner as a road-going vehicle. A vehicle's control system may therefore have different drive modes that each configure the vehicle to accommodate the manner in which the vehicle is driven, the surface on which the vehicle is driven, etc. A vehicle may also tow a trailer and may be configured to facilitate such use. Generally, the drive mode may be selected by the user. Alternatively, the control system may suggest (or select) an appropriate drive mode based on the vehicle operating conditions.

Additionally, the drive modes may include an autonomous drive mode that enables the control system to operate the vehicle with (or without) driver supervision and intervention. The Society for Automotive Engineers (SAE) published SAE J3016 in January 2014 (entitled “Taxonomy and Definitions for Terms Related to Driving Automation Systems for On-Road Motor Vehicles”, revised April 2021) that defines six levels of driving automation for vehicles operating on roadways. SAE's Levels include Level 0 (no driving automation), Level 1 (driver assistance), Level 2 (partial driving automation), Level 3 (conditional driving automation), Level 4 (high driving automation), and Level 5 (full driving automation).

Generally, each SAE Level defines the degree to which driver support and automated driving features provided by the control system participate in the dynamic driving task (DDT). The SAE generally defines the DDT as all the real-time functions required to operate a vehicle on the roadway, which includes tactical and operational functions but not strategic functions (such as scheduling, trip planning, or determining the waypoints and stops). For example, the DDT includes lateral (side-to-side) vehicle motion control, longitudinal (forward and backward) vehicle motion control, object and event detection and response, communicating with other vehicles via signaling, lighting, sounding the horn, etc. Expressed another way, the driver support and automated driving features that are engaged at any particular time determine the SAE Level of driving autonomy for the vehicle.

For SAE Levels 0, 1 and 2, the driver performs the DDT (even if the driver is not steering and the driver's feet are off the pedals), and must steer, brake, and accelerate as needed to maintain safety. SAE Level 0 includes driver support features that provide warnings and momentary assistance, such as an automatic emergency braking feature, a blind spot warning feature, a lane departure warning feature, etc. SAE Level 1 includes driver support features that provide steering or braking/acceleration support, such as a lane centering feature or an adaptive cruise control feature, etc. SAE Level 2 includes driver support features that provide steering and braking/acceleration support at the same time, such as the lane centering feature and the adaptive cruise control feature. The driver support features provided by the control system may be selected (engaged) and de-selected (disengaged) by the driver.

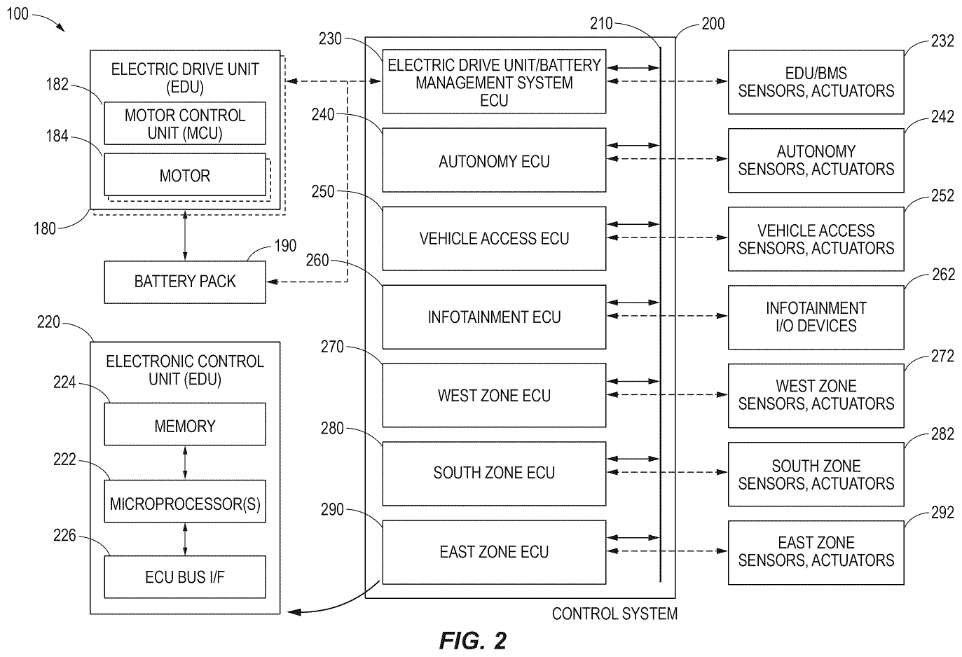

For SAE Levels 3, 4, and 5, an automated driving system (ADS) may perform the DDT. Generally, the vehicle control system may include a number of electronic control units (ECUs) that are apportioned between certain functions and control zones of the vehicle, such as the control system 200 discussed below with respect to FIG. 2. Due to its criticality and complexity, the ADS may be executed by a dedicated ECU, such as the Autonomy ECU 240 (FIG. 2). The ADS may provide one or more autonomous driving modes corresponding to SAE Levels 3, 4, and/or 5, such as a Level 3 (L3) autonomous driving mode, a Level 4 (L4) autonomous driving mode, and/or a Level 5 (L5) autonomous driving mode.

SAE Level 3 includes automated driving features that drive the vehicle under limited conditions, such as a traffic jam feature, a chauffeur feature, etc. SAE Level 4 also includes automated driving features that drive the vehicle under limited conditions, such as a local driverless taxi feature, etc. SAE Level 5 includes automated driving features that drive the vehicle under all conditions. SAE Levels 4 and 5 do not require that the driver takeover the DDT during autonomous operation. The automated driving features provided by the ADS may be selected (engaged) and de-selected (disengaged) by the driver.

However, SAE Level 3 requires that the driver takeover the DDT during autonomous operation when requested by the ADS. For example, when operating under the L3 autonomous driving mode, the ADS may determine that one or more conditions required for autonomous operation under SAE Level 3 are no longer satisfied, and may request that the driver takeover the DDT. In this situation, the ADS sends a DDT takeover request to the ECU that controls the visual and audio systems in the cabin of the vehicle, such as the Infotainment ECU 260 (FIG. 2).

The DDT takeover request may be presented to the driver as a visual alert on one or more displays in the cabin of the vehicle. The DDT takeover request may also be presented to the driver as an audio alert broadcast through the audio system in the cabin of the vehicle, alone or in combination with the visual alert. In response, the driver may simply assume manual control of the steering wheel, accelerator pedal, and brake pedal. Once the ADS senses that the driver has resumed the DDT, the ADS exits the L3 autonomous driving mode.

It is important to refocus the driver's attention back on the DDT as quickly as possible in order to prevent the ADS from executing a minimal risk maneuver (MRM) to reduce the risk of an adverse event. For example, the MRM may include canceling power and smoothly decelerating the vehicle in order to bring the vehicle to a safe, stopped state (also known as a minimal risk condition or MRC).

In certain situations, the Infotainment ECU 260 may not be able to present the DDT takeover request to the driver. Additionally, the driver may not be paying attention to the displays, which may have also gone blank due to issues related to the displays or the operation of the Infotainment ECU 260. For example, the Infotainment ECU 260 may have lost communication with the displays and the audio system in the cabin of the vehicle, which prevents the presentation of the DDT takeover request to the driver. In another example, the operation of the Infotainment ECU 260 may be degraded, and the Infotainment ECU 260 may not be responding to external requests, such as a DDT takeover request. In a further example, the Autonomy ECU 240 may have lost communication with the Infotainment ECU 260, which prevents the transmission of the DDT takeover request to the Infotainment ECU 260 (such as due to a power loss at the Infotainment ECU 260, etc.).

Embodiments of the present disclosure advantageously provide an audible takeover warning system for an L3 autonomous driving mode that bypasses the Infotainment ECU 260 to increase the likelihood that the DDT takeover request will be noticed by the driver. Rather than providing an alternative communication path to the displays and the audio system in the cabin (which may not be functioning) or adding a dedicated audio alarm system to the cabin, the Autonomy ECU 240 may send the DDT takeover request to a zonal controller ECU (such as the West Zone ECU 270 depicted in FIG. 2), which sends an audible alert request to a controller for a haptic input device located in the steering wheel to generate an audible tone instead of a haptic vibration. The audible tone has a frequency in the audible spectrum (about 20 Hz to 20 kHz), which will draw the attention of the driver to the need to resume control of the DDT, regardless of the status of the displays and the audio system in the cabin.

While described in the context of DDT takeover requests, embodiments of the present disclosure may provide audible alerts for other types of vehicle control system conditions. Each audible alert may be generated at a different audible frequency so that the driver may distinguish the audible alerts from one another.

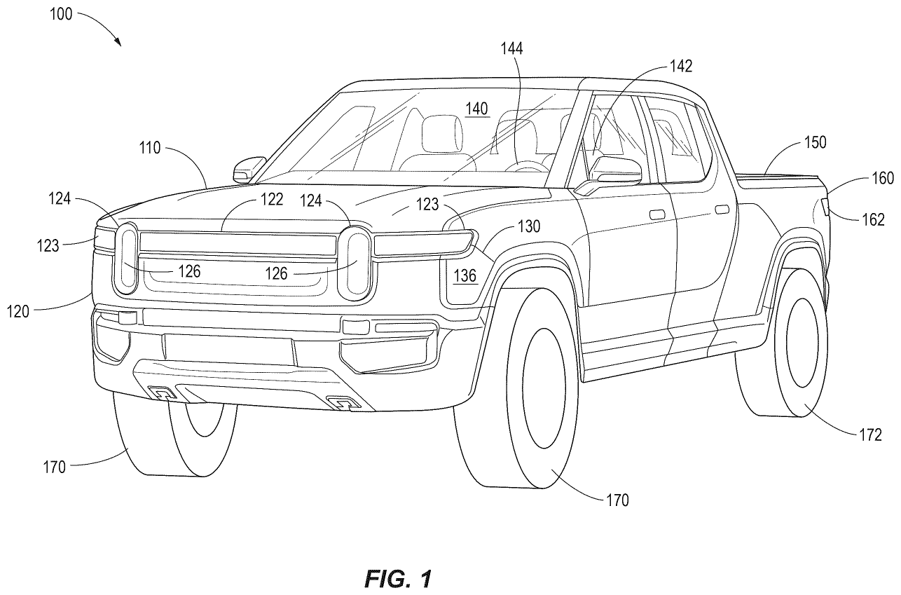

FIG. 1 depicts a diagram of an example electric vehicle 100, in accordance with embodiments of the present disclosure. While the electric vehicle 100 is used to discuss certain aspects of the present disclosure, the principles described herein may be applied to any type of vehicle with automated driving features, such as an ADS.

Electric vehicle 100 includes, inter alia, a frame and body 110, an electrical power storage and distribution system, a propulsion system, a suspension system, a steering system, a control system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light rings 124, headlights 126, charging port 130 with charging port cover 136 concealing charging connector socket, driver/passenger compartment or cabin 140 including a driver's seat 142 and a steering wheel 144, bed 150, rear end 160 with rear taillights 162, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more electronic control units (ECUs), one or more electric drive unit (EDUs), front wheels 170, rear wheels 172, etc. The electrical power storage and distribution system may include, inter alia, one or more ECUs, a battery enclosure including a housing containing a traction battery, a vehicle charging subsystem including charging port 130, a high voltage (HV) wiring harness connecting the traction battery to the other HV electrical system components, such as the EDUs, etc.

A single motor EDU may be used to drive front wheels 170 (front wheel drive) or rear wheels 172 (rear wheel drive). Additionally, a single motor EDU may be used to drive front wheels 170 and a single motor EDU may be used to drive rear wheels 172 (four wheel drive). A dual motor EDU may be used to independently drive front wheels 170 (independent front wheel drive) or rear wheels 172 (independent rear wheel drive). Additionally a dual motor EDU may be used to independently drive both front wheels 170 and a dual motor EDU may be used to independently drive both rear wheels 172 (independent four wheel drive).

FIG. 2 presents a block diagram of example components of the electric vehicle 100, in accordance with embodiments of the present disclosure.

Generally, electric vehicle 100 includes control system 200 that is configured to perform the functions necessary to operate electric vehicle 100. In certain embodiments, control system 200 includes a number of ECUs 220 coupled to ECU bus 210 (also known as a controller area network or CAN bus). Each ECU 220 performs a particular set of functions, and includes, inter alia, one or more processors 222 coupled to memory 224 and ECU bus interface (I/F) 226. Control system 200 may also include one or more wireless network interfaces to provide a wireless communications hub for electric vehicle 100, such as a Bluetooth (BT) or Bluetooth Low Energy (BLE) transmitter/receiver (or transceiver), a WiFi transceiver, a cellular network transceiver, etc.

Generally, control system 200 may be coupled to sensors (such as cameras, radar sensors, ultrasonic sensors, a global positioning system (GPS) receiver, etc.), actuators (such as electric, hydraulic, pneumatic, etc.), input/output (I/O) devices (such as displays, touchscreen displays, mechanical, electrical and electro-mechanical switches, etc.), as well as other components within the propulsion system, the electrical power storage and distribution system, the suspension system, the steering system, the auxiliary and accessory systems, etc., such as one or more EDUs 180 (with a motor control unit 182 and a motor 184), a battery pack 190, etc.

Processor 222 may be a microcontroller unit, a microprocessing unit, a central processing unit (CPU), a programmable logic device (PLD), a complex PLD, a field programmable gate array (FPGA), an application specific integrated circuit (ASIC), etc. Memory 224 may include non-volatile and/or volatile memory, such as read only memory (ROM), random access memory (RAM), static RAM (SRAM), dynamic RAM (DRAM), flash memory, etc. In certain embodiments, control system 200 may include a number of system-on-chips (SoCs). Each SoC may include a number of multi-core processors coupled to a high-speed interconnect and on-chip memory that provide more robust functionality and performance than an ECU 220 with a single processor 222.

In certain embodiments, control system 200 may include an electric drive unit/battery management system (EDU/BMS) ECU 230, an autonomy ECU 240, a vehicle access ECU 250, an infotainment ECU 260, a West Zone ECU 270, a south zone ECU 280, and an east zone ECU 290.

The EDU/BMS ECU 230 provides functionality related to the propulsion and electrical power storage and distribution system, and is coupled to EDU/BMS sensors and actuators 232. The autonomy ECU 240 provides functionality related to autonomous vehicle activities, such as sensor data processing, image recognition, driver support features, automated driving features, an ADS, etc., and is coupled to autonomous sensors and actuators 242, such as cameras, radars, etc. The vehicle access ECU 250 provides functionality related to accessing and securing the vehicle, such as wireless key fobs, a security system, etc., and is coupled to vehicle access sensors and actuators 252. The infotainment ECU 260 provides functionality related to presenting vehicle information and receiving commands to control the various subsystems (such as HVAC, lighting, etc.), as well as functionality related to various media sources, such as HD and satellite radio, and natively-integrated media provider applications. The infotainment ECU 260 is coupled to the infotainment I/O devices 262 (such as touchscreen displays, an audio system including speakers, etc.). Generally, sensors and actuators 232, 242, 252 may also include one or more I/O devices (such as haptic input devices, etc.).

The West Zone ECU 270, the south zone ECU 280, and the east zone ECU 290 are also known as zonal controllers, and each zonal controller may control a subset of the sensors and actuators of the electric vehicle 100. The subset of sensors and actuators controlled by each zonal controller may be generally assigned based on location within the electric vehicle 100. For example, the West Zone ECU 270 may control the sensors and actuators 272 on a driver side of the electric vehicle 100, such as haptic input devices located on the steering wheel 144, etc., the south zone ECU 280 may control the sensors and actuators 282 in a rear portion of the electric vehicle 100, and the east zone ECU 290 may control the sensors and actuators 292 on a passenger side of the electric vehicle 100.

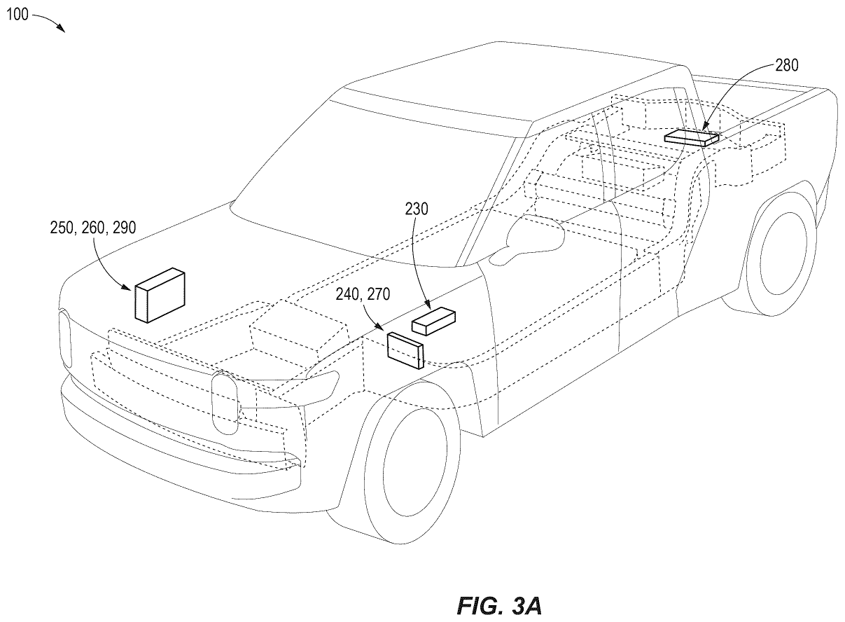

FIG. 3A presents a diagram of example components of the control system 200 for the electric vehicle 100, in accordance with embodiments of the present disclosure.

In certain embodiments, the EDU/BMS ECU 230, the autonomy ECU 240, the vehicle access ECU 250, the infotainment ECU 260, the West Zone ECU 270, the south zone ECU 280, and the east zone ECU 290 may be arranged as depicted in FIG. 3A. Other locations for each ECU are also supported.

FIG. 3B presents a diagram of example components of a control system zone for the electric vehicle 100, in accordance with embodiments of the present disclosure.

In certain embodiments, the west zone may include the West Zone ECU 270 and the west zone sensors and actuators 272, as depicted in FIG. 3B. Other locations and arrangements for the West Zone ECU 270 and the west zone sensors and actuators 272 are also supported.

FIG. 3C presents a diagram of example components of another control system zone for the electric vehicle 100, in accordance with embodiments of the present disclosure.

In certain embodiments, the south zone may include the south zone ECU 280 and the south zone sensors and actuators 282, as depicted in FIG. 3C. Other locations and arrangements for the south zone ECU 280 and the south zone sensors and actuators 282 are also supported.

FIG. 3D presents a diagram of example components of another control system zone for the electric vehicle 100, in accordance with embodiments of the present disclosure.

In certain embodiments, the east zone may include the east zone ECU 290 and the east zone sensors and actuators 292, as depicted in FIG. 3D. Other locations and arrangements for the east zone ECU 290 and the east zone sensors and actuators 292 are also supported.

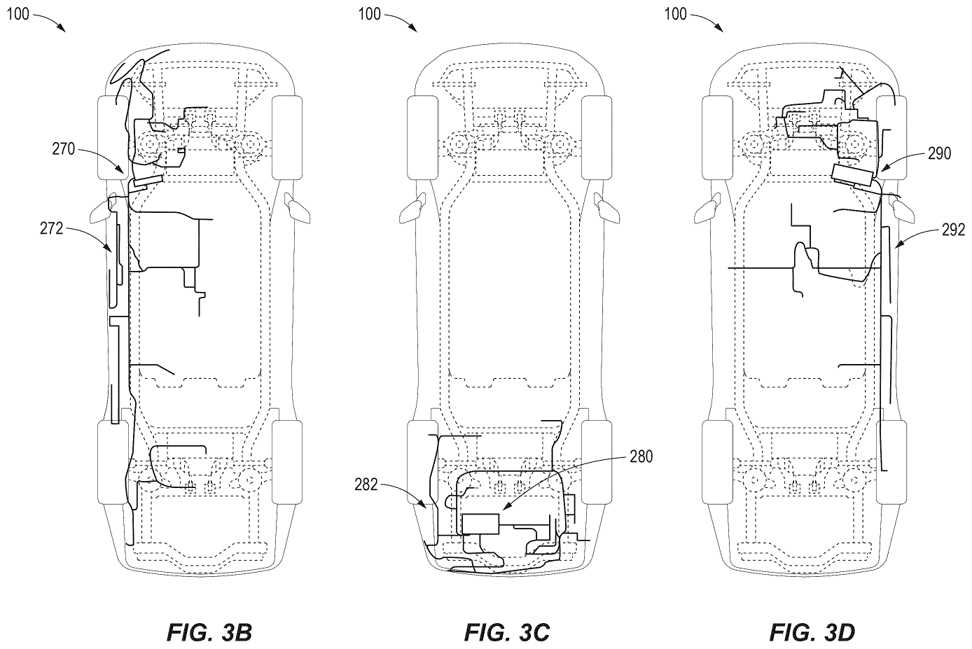

FIG. 4 depicts a portion of an example cabin 140 for the electric vehicle 100, in accordance with embodiments of the present disclosure.

In certain embodiments, steering wheel 144 includes one or more haptic input devices 145, such as a haptic scroll wheel (two haptic scroll wheels are depicted). Each haptic scroll wheel may provide user input to the control system 200, as well as haptic feedback from the control system 200, such as tactile vibrations, clicks, etc. Advantageously, the haptic scroll wheels may also provide an audible tone that alerts the driver to a particular situation, such as the need to resume the DDT during operation in an L3 autonomous driving mode.

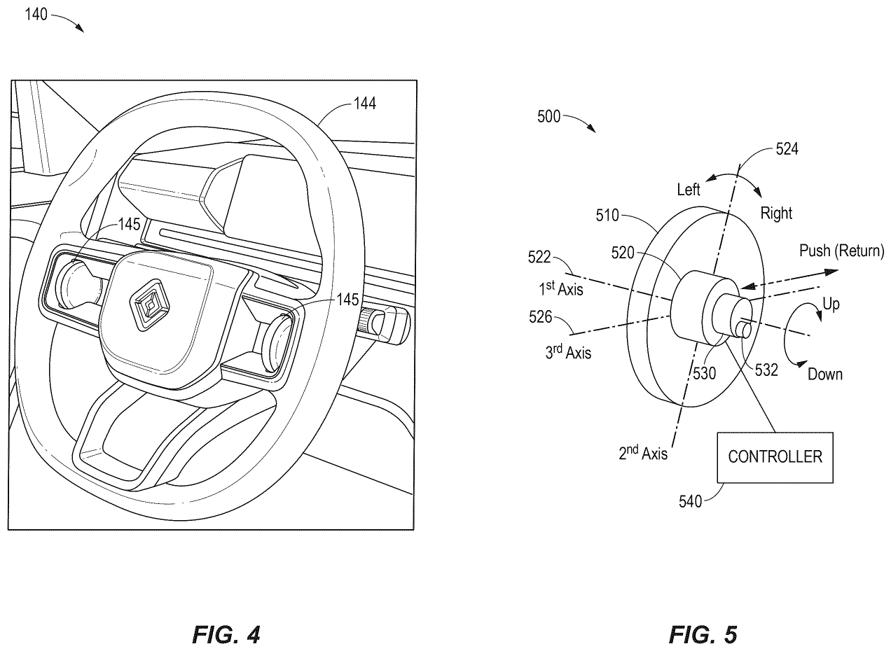

FIG. 5 depicts a diagram of an example haptic scroll wheel 500 for the electric vehicle 100, in accordance with embodiments of the present disclosure.

In certain embodiments, the haptic scroll wheel 500 may include a wheel 510, a mount 520 coupled to the wheel 510, a DC motor 530 attached to the mount 520 and coupled to the wheel 510, and a controller 540 coupled to the DC motor 530. The mount 520 includes a number of sensors that are coupled to the controller 540.

The mount 520 is attached to the steering wheel 144, and provides a number of degrees of freedom for the wheel 510, such as rotation about a 1^{st} axis 522, rotation about a 2^{nd} axis 524, and translation along a 3^{rd} axis 526. The 2^{nd} axis 524 is perpendicular to the 1^{st} axis 522, and the 3^{rd} axis 526 is perpendicular to the 1^{st} axis 522 and the 2^{nd} axis 524.

Generally, the 1^{st} axis 522 may be known as a scroll axis, the 2^{nd} axis 524 may be known as a tilt axis, and the 3^{rd} axis may be known as a longitudinal axis. The sensors may include a 1^{st} rotation sensor configured to measure the rotation about the 1^{st} axis 522, a 2^{nd} rotation sensor configured to measure the rotation about the 2^{nd} axis 524, and a translation sensor configured to measure the translation along the 3^{rd} axis 526.

The 1^{st} rotation sensor may be a rotary encoder that measures the rotation of the wheel 510 through 360° about the scroll axis. Rotation of the wheel 510 about the scroll axis allows the driver to scroll up and down though a user interface window that extends past the top and bottom edges of a display in the cabin.

The 2^{nd} rotation sensor may also be a rotary encoder that measures the rotation of the wheel 510 through about ±45° or so about the tilt axis. Alternatively, the 2^{nd} rotation sensor may be a switch that is engaged when the wheel 510 reaches a maximum tilt angle (such as ±45°, etc.). Rotation of the wheel left or right allows the driver to scroll left or right (respectively) through a user interface window, or select a widget in the user interface, such as an icon, etc.

The translation sensor is a switch that is engaged when the wheel 510 reaches a maximum displacement (such as 0.125 inches, 0.250 inches, etc.). A spring coupled to the wheel 510 returns the wheel 510 to zero displacement along the 3^{rd} axis when the driver releases actuation pressure on the wheel 510. Engaging the switch allows the user to select a widget in the user interface, such as an icon, etc.

The DC motor 530 may be a 3-phase brushless DC (BLDC) motor that includes an output shaft and three input ports, one input port for each phase. An unbalanced mass 532 may be coupled to the output shaft to cause vibration when the output shaft rotates. The DC motor 530 may be driven by two control signals for 2 phase operation, or three control signals for 3 phase operation. Other types of DC motors may also be used.

The controller 540 is configured to receive and process data from the sensors in the mount 520, and to generate control signals that drive the DC motor 530 to provide tactile vibrations, clicks, etc., in response to commands received from the ECUs 220 of the control system 200. For example, the control signals may include three different PWM control signals, one for each input port of the DC motor 530. In another example, the control signals may include two different PWM control signals, one for a respective input port of the DC motor 530 with the third input port being unused.

Additionally, the controller 540 is configured to generate a control signal that includes a single phase PWM signal that is provided to at least two input ports of the DC motor 530. The single phase PWM signal has a frequency that is within the audible spectrum (about 20 Hz to 20 kHz). Rather than cause rotation of the output shaft of the DC motor 530, the single phase PWM signal causes the DC motor 530 to emit an audible tone at the same frequency as the single phase PWM signal. In certain embodiments, the single phase PWM signal may be simultaneously provided to the input ports of the DC motor 530. In other embodiments, the single phase PWM signal may arrive at slightly different times at the input ports of the DC motor 530, which may cause a slight initial rotation of the output shaft but does not effect the generation of the audible tone.

In certain embodiments, the frequency has an upper limit of about 5 kHz. In some embodiments, the frequency may be between 1 kHz and 4 kHz. In other embodiments, the frequency may be between 2 kHz and 3 kHz. In further embodiments, the frequency may be between 1.7 kHz and 1.9 kHz.

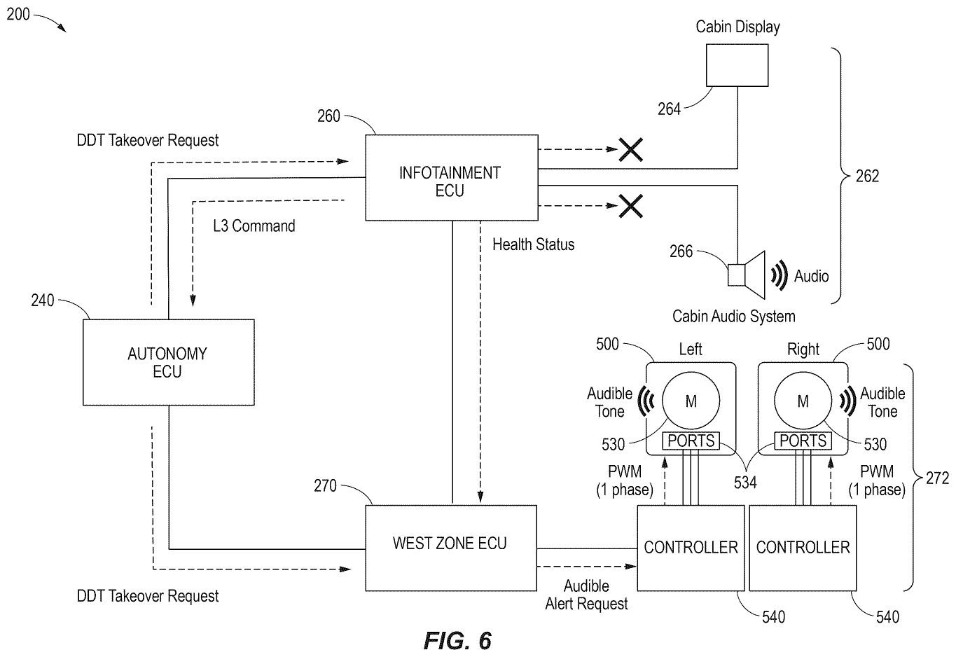

The controller 540 is configured to generate the single phase PWM control signal for the DC motor 530 in response to receiving an audible alert request from an ECU 220 of the control system 200. For example, the audible alert request may be received from the West Zone ECU 270, which has received a DDT takeover request from the Autonomy ECU 240. The interactions between the Autonomy ECU 240, the Infotainment ECU 260, and the West Zone ECU 270 are discussed in more detail with respect to FIG. 6.

FIG. 6 depicts a block diagram of example components of the control system 200 of the electric vehicle 100, in accordance with embodiments of the present disclosure.

In response to receiving an L3 command from a user interface (such as from the Infotainment ECU 260), the Autonomy ECU 240 may execute an ADS that controls the DDT during an L3 autonomous driving mode. During execution of the L3 autonomous driving mode, the ADS may determine that one or more conditions required for autonomous operation under SAE Level 3 are no longer satisfied, and may request that the driver takeover the DDT. In this situation, the Autonomy ECU 240 sends a DDT takeover request to the Infotainment ECU 260, which controls the visual and audio systems in the cabin of the vehicle. As described above with respect to FIG. 2, the Infotainment ECU 260 is coupled to the I/O devices 262, such as the cabin display 264, and the cabin audio system 266.

During normal operation, the Infotainment ECU 260 presents a visual alert on the cabin display 264 that the driver needs to resume the DDT, and may also broadcast an audio alert through the cabin audio system 266. In response, the driver may simply assume manual control of the steering wheel, accelerator pedal, and brake pedal. Once the ADS senses that the driver has resumed the DDT, the ADS exits the L3 autonomous driving mode.

The Autonomy ECU 240 also sends the DDT takeover request to the West Zone ECU 270, which is coupled to, and controls, the sensors and actuators 272, such as the left and right haptic scroll wheels 500 attached to the steering wheel 144. Additionally, the Infotainment ECU 260 periodically sends a health status message to the West Zone ECU 270, which indicates whether the cabin display 264 and the cabin audio system 266 are operating nominally and are able to present visual and audio alerts to the driver. In some embodiments, the Infotainment ECU 260 sends the health status message to the West Zone ECU 270 as soon as the cabin display 264 and the cabin audio system 266 are determined not to be operating nominally and are unable to present visual and audio alerts to the driver.

As discussed above, in certain situations, the Infotainment ECU 260 is not be able to present the DDT takeover request to the driver. In response to receiving the DDT takeover request from the Autonomy ECU 240, the West Zone ECU 270 inspects the most recent health status message received from the Infotainment ECU 260. If the cabin display 264 and the cabin audio system 266 are operating nominally and are able to present visual and audio alerts to the driver, the West Zone ECU 270 takes no further action.

However, if the cabin display 264 and the cabin audio system 266 are not operating nominally and are unable to present visual and audio alerts to the driver, or if the health status message has not been received within a fault tolerant time interval (such as 100 milliseconds (ms), 250 ms, 500 ms, 750 ms, 1 second, 2 seconds, etc.), then the West Zone ECU 270 generates and transmits an audible alert request to the controllers 540 of the left and right haptic scroll wheels 500.

In response to receiving the audible alert request, each controller 540 generates and transmits a single phase PWM control signal to at least two input ports 534 of the respective DC motor 530. In certain embodiments, the audible alert request includes a frequency for the single phase PWM control signal, which controls the frequency of the audio tone generated by each DC motor 530. In some embodiments, the audible alert request also includes an amplitude for the single phase PWM control signal, which controls the loudness (SPL) of the audio tone generated by each DC motor 530.

In response to the audible tone generated by the DC motors 530, the driver may assume manual control of the steering wheel, accelerator pedal, and brake pedal. Once the ADS senses that the driver has resumed the DDT, the ADS exits the L3 autonomous driving mode.

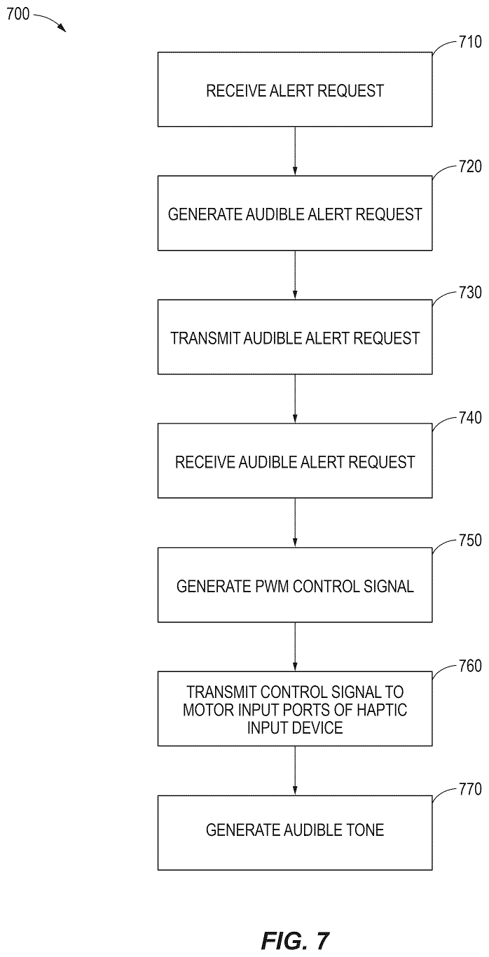

FIG. 7 presents a process flow diagram 700 for generating an audible alert in the electric vehicle 100, in accordance with embodiments of the present disclosure.

The functionality described at blocks 710, 720, and 730 may be performed at an ECU, such as the West Zone ECU 270 (as described above with respect to FIG. 6).

At 710, an alert request is received from another ECU. For example, the alert request may be a DDT takeover request received from the Autonomy ECU 240 over the ECU bus 210.

At 720, an audible alert request is generated.

At 730, the audible alert request is transmitted to a controller for a haptic input device, such as the controller 540 for the left haptic scroll wheel 500 attached to the steering wheel 144. In certain embodiments, the audible alert request may also be transmitted to a controller for a second haptic input device, such as the controller 540 for the right haptic scroll wheel 500 attached to the steering wheel 144.

The functionality described at blocks 740, 750, and 760 may be performed at the controller, such as the controller 540 (as described above with respect to FIGS. 5, 6).

At 740, the audible alert request is received from the ECU, such as the West Zone ECU 270.

At 750, a single phase PWM control signal is generated.

At 760, the single phase PWM control signal is transmitted to at least two input ports of a haptic input device motor, such as the DC motor 530 of the left (and/or right) haptic scroll wheel 500 attached to the steering wheel 144.

The functionality described at block 770 may be performed at the haptic input device, such as the left (and/or right) haptic scroll wheel 500 (as described above with respect to FIGS. 5, 6).

At 770, an audible tone is generated by the DC motor 530 based on the single phase PWM control signal.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A system, comprising:
a haptic input device attached to a steering wheel of a vehicle, the haptic input device comprising:
a wheel comprising at least one degree of freedom,
at least one sensor coupled to the wheel, and
a direct current (DC) motor coupled to the wheel, the DC motor comprising at least two input ports and an output shaft, the DC motor configured to:
generate an audible tone when a control signal is provided to the input ports, the control signal comprising a single phase pulse width modulation (PWM) signal, and
generate an output shaft rotation when different control signals are provided to the input ports; and
a controller coupled to the haptic input device, the controller configured to:
receive an audible alert request from an electronic control unit (ECU) of the vehicle,
in response to receiving the audible alert request, generate the control signal, and
transmit the control signal to the input ports of the motor.

2. The system of claim 1, further comprising an additional ECU configured to:
in response to receiving a command from a user interface of the vehicle, execute an L3 autonomous driving mode that controls a dynamic driving task (DDT);
during execution of the L3 autonomous driving mode, determine that a driver resume control of the DDT;
generate a DDT takeover request; and
send the DDT takeover request to the ECU.

3. The system of claim 2, wherein the ECU is further configured to:
receive the DDT takeover request from the additional ECU; and
in response to receiving the DDT takeover request:
generate the audible alert request, and
transmit the audible alert request to the controller,
wherein the audible alert request includes an audible frequency.

4. The system of claim 1, wherein the single phase PWM signal comprises a frequency having an upper limit of about 5 kHz, and the audible tone comprises the frequency.

5. The system of claim 4, wherein the frequency is between 1 kHz and 4 kHz.

6. The system of claim 5, wherein the frequency is between 2 kHz and 3 kHz.

7. The system of claim 5, wherein the frequency is between 1.7 kHz and 1.9 kHz.

8. The system of claim 1, wherein the motor is a three phase, brushless DC motor comprising three input ports, and the control signal is provided to at least two of the input ports.

9. The system of claim 8, wherein the motor further comprises an unbalanced mass coupled to the output shaft.

10. The system of claim 1, wherein the at least one degree of freedom comprises rotation about a first axis, rotation about a second axis perpendicular to the first axis, and translation along a third axis perpendicular to the first and second axes.

11. The system of claim 10, wherein the at least one sensor comprises a first rotation sensor configured to measure the rotation about the first axis, a second rotation sensor configured to measure the rotation about the second axis, and a translation sensor configured to measure the translation along the third axis.

12. The system of claim 11, wherein the first axis is a scroll axis, the second axis is a tilt axis, and the third axis is a longitudinal axis.

13. The system of claim 12, wherein the first rotation sensor is a rotary encoder, the second rotation sensor is a switch, and the translation sensor is a switch.

14. A method for generating an audible alert in a vehicle, comprising:
at an electronic control unit (ECU):
receiving an alert request from another ECU;
generating an audible alert request;
transmitting the audible alert request to a controller of a haptic input device;
at the controller:
receiving the audible alert request from the ECU;
generating a single phase pulse width modulated (PWM) control signal;
transmitting the single phase PWM control signal to at least two input ports of a DC motor of the haptic input device; and
at the DC motor:
generating an audible tone based on the single phase PWM control signal.

15. The method of claim 14, wherein the alert request is a dynamic driving task (DDT) takeover request.

16. The method of claim 15, further comprising:
at an additional ECU:
in response to receiving a command from a user interface of the vehicle, executing an L3 autonomous driving mode that controls the DDT;
during execution of the L3 autonomous driving mode, determining that a driver resume control of the DDT;
generating a DDT takeover request;
sending the DDT takeover request to the ECU;
at the ECU:
receiving the DDT takeover request from the additional ECU; and
in response to receiving the DDT takeover request, generating the audible alert request, and transmitting the audible alert request to the controller,
wherein the audible alert request includes an audible frequency.

17. The method of claim 14, wherein the single phase PWM signal comprises a frequency having an upper limit of about 5 kHz, and the audible tone comprises the frequency.

18. The method of claim 17, wherein:
the frequency is between 1 kHz and 4 kHz;
the frequency is between 2 kHz and 3 kHz; or
the frequency is between 1.7 kHz and 1.9 kHz.

19. The method of claim 14, wherein the DC motor is a three phase, brushless DC motor comprising three input ports, and the single phase PWM control signal is provided to at least two of the input ports.

20. The method of claim 14, wherein the haptic input device further comprises:
a wheel comprising at least one degree of freedom; and
at least one sensor coupled to the wheel,
wherein:
the at least one degree of freedom comprises rotation about a first axis, rotation about a second axis perpendicular to the first axis, and translation along a third axis perpendicular to the first and second axes,
the at least one sensor comprises a first rotation sensor configured to measure the rotation about the first axis, a second rotation sensor configured to measure the rotation about the second axis, and a translation sensor configured to measure the translation along the third axis,
the first axis is a scroll axis, the second axis is a tilt axis, and the third axis is a longitudinal axis, and
the first rotation sensor is a rotary encoder, the second rotation sensor is a switch, and the translation sensor is a switch.
